(19) United States
(12) Patent Application Publication
(10) Pub. No.: US 2024/0377176 A1
(43) Pub. Date: Nov. 14, 2024

(54) GAUGE FOR IDENTIFYING A WHEEL FASTENER

(71) Applicant: RB Distribution, Inc., Colmar, PA (US)

(72) Inventors: Sean Ermigiotti, Perkasie, PA (US); Alexander Tkach, Pipersville, PA (US); Chris Allebach, Lansdale, PA (US); Devin Swift, Drexel Hill, PA (US); Eric Tryson, Lansdale, PA (US); Jeffrey Martin, Philadelphia, PA (US); Ricardo Llorente Ruiz, Perkasie, PA (US)

(73) Assignee: RB Distribution, Inc., Colmar, PA (US)

(21) Appl. No.: 18/658,401

(22) Filed: May 8, 2024

Related U.S. Application Data
(60) Provisional application No. 63/500,781, filed on May 8, 2023.

(51) Int. Cl. G01B 3/04; G01B 5/08

(52) U.S. Cl. CPC G01B 3/04; G01B 5/08

(57) ABSTRACT

A gauge for identifying a seat contacting surface configuration of a wheel fastener. The gauge includes a body defining an upper surface and a front face with at least one gauge slot defined in the body. Each gauge slot extends from the top surface and has a circumferential wall extending about a portion thereof with an open area defined in the circumferential wall along the front face and opening into at least a portion of the gauge slot. Each gauge slot including at least a seat portion adjacent the upper surface and defining a seat corresponding with a given seat contacting surface configuration of a wheel fastener. A gauge assembly further including a sizing gauge and a method of identifying a seat contacting surface configuration are further disclosed.

### CROSS REFERENCE TO RELATED APPLICATION

This application claims the benefit of U.S. Provisional application No. which was filed on May 8, 2024 and is incorporated by reference as if fully set forth.

### BACKGROUND

There are known devices for sizing fasteners, such as nuts and screws. These devices have a shortcoming in that they only address one aspect of the fit. This limitation is problematic when it comes to properly identifying and sizing vehicle wheel fasteners which may have more than one geometric feature.

### SUMMARY

Referring to FIGS. 1A-1B, various types and sizes of wheel fasteners 10a-10g may be utilized to secure a wheel 18 to a wheel hub or the like. Lug nuts 10a-10e have a body 12a-e with a threaded internal bore (not shown) configured to threadably engage a respective wheel stud (not shown) extending from the wheel hub. Each of the bodies 12a-12e has a seat contacting surface 13a-e having a geometric configuration which is intended to match a corresponding seat 22a-e defined in the wheel rim 20a-20c. The lug nuts 10a, 10b illustrated in FIGS. 1A and 1B have a seat contacting surface 13a, 13b with a tapered or conical configuration, with the lug nut 10b illustrated in FIG. 1B having an extension portion 11 extending beyond the tapered portion. Both of these lug nuts 10a, 10b are configured to mate with a rim seat 22a having a corresponding tapered portion. When the lug nuts 10a, 10b are tightened, the tapered portions of seat contacting surfaces 13a, 13b sit flush within the tapered rim seat 22a to provide a secure fit, centering and the like. Referring to FIG. 1C, the seat contacting surface 13c of lug nut 10c has a radius or ball configuration configured to mate with the radius configuration of the rim seat 22b. The lug nuts 10d, 10e illustrated in FIGS. 1D and 1E have a seat contacting surface 13d, 13e with a flat configuration, with the lug nut 10e illustrated in FIG. 1E having a flat washer 14 thereon. Both of these lug nuts 10d, 10e are configured to mate with a rim seat 22c having a corresponding flat configuration.

The lug bolts 10f and 10g illustrated in FIGS. 1F and 1G are similar to the lug bolts, however, they include a threaded stud 16 extending from the body 12f-12g configured to engage a threaded bore (not shown) in the wheel hub. Similar to the bolts, each of the lug bolts 10f, 10g has a seat contacting surface 13f, 13g of the body 12f, 12g with a geometric configuration which is intended to match a corresponding seat 22a, 22b defined in the wheel rim. In the illustrated embodiments, the lug bolt 12f has a seat contacting surface 13f with a tapered or conical configuration configured to mate with a rim seat 22a having a corresponding tapered portion. Referring to FIG. 1G, the seat contacting surface 13g of lug bolt 10g has a radius or ball configuration configured to mate with the radius configuration of the rim seat 22b.

At times, it is necessary to replace a lug nut or lug bolt. If an individual replacing their lug nut/lug bolt does not choose a replacement having a seat contacting surface configuration that corresponds to the configuration of the wheel rim seats of their vehicle, the lug nuts/bolts will not properly sit relative to the rim and such could cause a failure or damage to the vehicle.

### BRIEF DESCRIPTION OF THE DRAWINGS

FIGS. 1A-1G are front views illustrating different types of wheel fasteners and corresponding wheel rim seats;

FIG. 2 is a front perspective view of an illustrative gauge for identifying a wheel fastener;

FIG. 3 is a top plan view of the gauge in FIG. 2;

FIG. 4 is a cross-sectional view along the line 4-4 in FIG. 3;

FIG. 5 is a rear perspective view of the gauge in FIG. 2;

FIGS. 6A and 6B are front views illustrating position of a tapered lag nut relative to a tapered gauge slot;

FIGS. 7A and 7B are front views illustrating position of a tapered nut bolt relative to a ball gauge slot;

FIG. 8 is a top perspective view illustrating the tapered lag nut positioned in the ball gauge slot;

FIGS. 9A and 9B are front views illustrating position of a ball lag bolt relative to a ball gauge slot;

FIGS. 10A and 10B are front views illustrating position of a ball lag bolt relative to a tapered gauge slot; and

FIG. 11 is a perspective view of a gauging assembly including the gauge for identifying a wheel fastener as illustrated in FIG. 2 and a sizing gauge.

### DETAILED DESCRIPTION

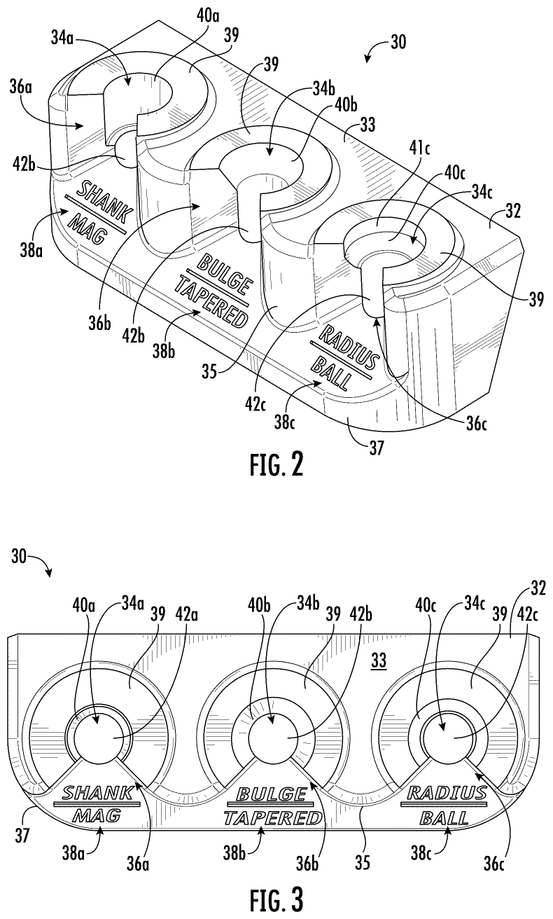

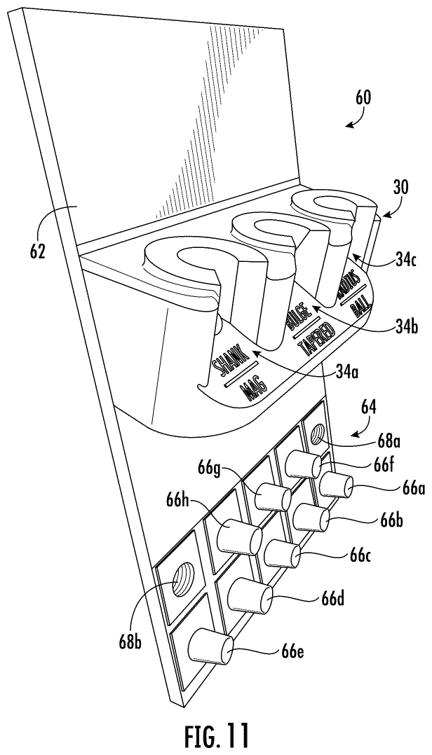

Referring to FIGS. 2-5, a gauge 30 in accordance with an embodiment of the disclosure will be described. The gauge 30 includes a body 32 defining an upper surface 33, a front face 35 and a base 37. A plurality of gauge slots 34a-34c are defined in the body 32 extending from the upper surface 33. While three gauge slots are shown in the illustrated embodiment, more or fewer may be provided. Each gauge slot 34a-34c has a circumferential wall 39 defined about a portion thereof, with the front portion having an open area 36a-36c, such that a user has an unobstructed view into at least the upper portion, adjacent the upper surface 33, of each gauge slot 34a-34c. As explained in more detail hereinafter, such open area 36a-36c allows the user to accurately confirm that their lug nut/bolt is of a particular style. Referring to FIG. 5, a rear surface 44 of the body 32 may be provided with mounting holes 46 or the like to facilitate direct mounting of the gauge 30 or attachment of the gauge 30 to a gauge assembly 60, as will be described with reference to FIG. 11.

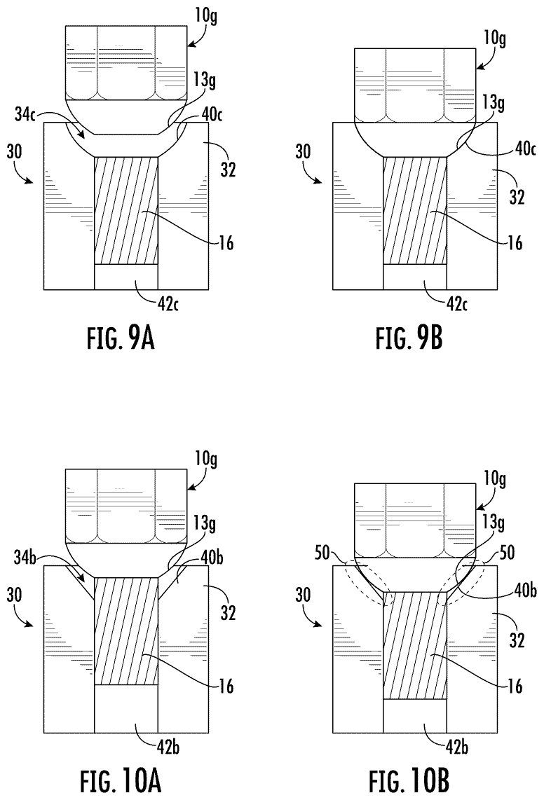

Each gauge slot 34a-34c generally includes a seat portion 40a-40c extending from the upper surface 33 and a through bore 42a-42c extending therefrom into the base 37. In the illustrated embodiment, the through bores 42a-42c extend through and out of the base 37 although such may not be required. The through bores 42a-42c are configured to allow the stud 16 of a lug bolt 10f, 10g or the extension portion 11 of a lug bolt 10b to be unobstructed while the seat contacting surface 13a-13g of the lug nut/bolt is positioned in the seat portion 40a-40c (see FIGS. 9A and 9B).

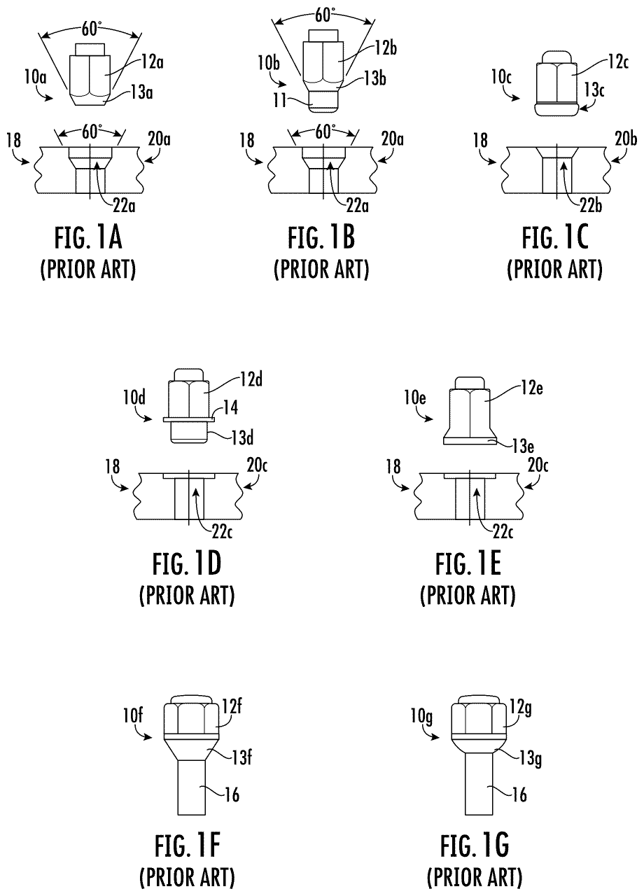

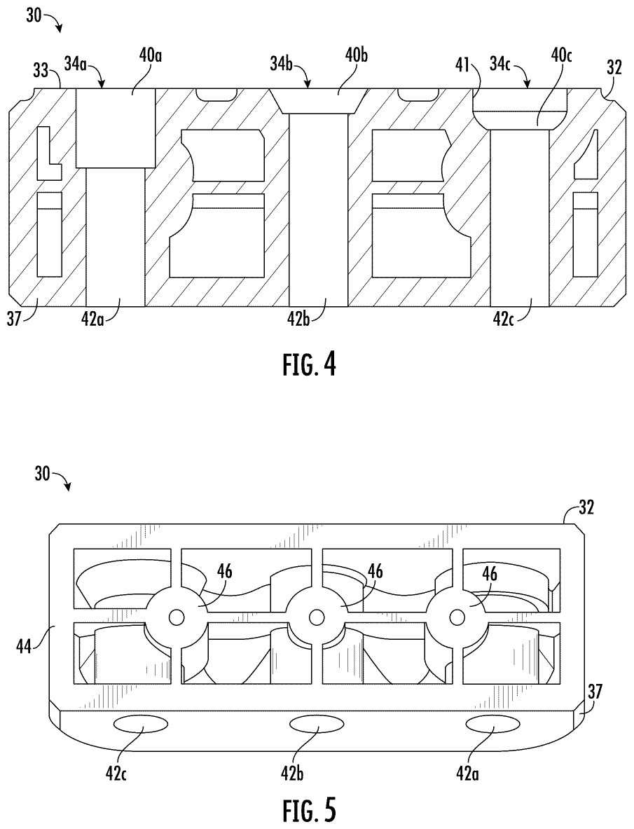

Referring to FIG. 4, the seat portion 40a-40b of each gauge slot 34a-34c is configured to receive a lug nut/bolt 10a-10g with a corresponding configuration. In the illustrated embodiment, the seat portion 40a of gauge slot 34a has a generally cylindrical configuration with the walls thereof generally perpendicular to the upper surface 33. The seat portion 40a is configured to identify lug nuts/bolts having a flat seat contacting surface, for example, as shown in FIGS. 1D and 1E. The seat portion 40b of gauge slot 34b has a conical surface extending inwardly from the upper surface 33. The seat portion 40b is configured to identify lug nuts/bolts having a tapered seat contacting surface, for example, as shown in FIGS. 1A, 1B and 1F. The seat portion 40c of gauge slot 34c includes a curved portion with a desired radius. As shown, a cylindrical portion 41 may extend between the curved portion and the upper surface 33. The seat portion 40c is configured to identify lug nuts/bolts having a radius or ball seat contacting surface, for example, as shown in FIGS. 1C and 1G.

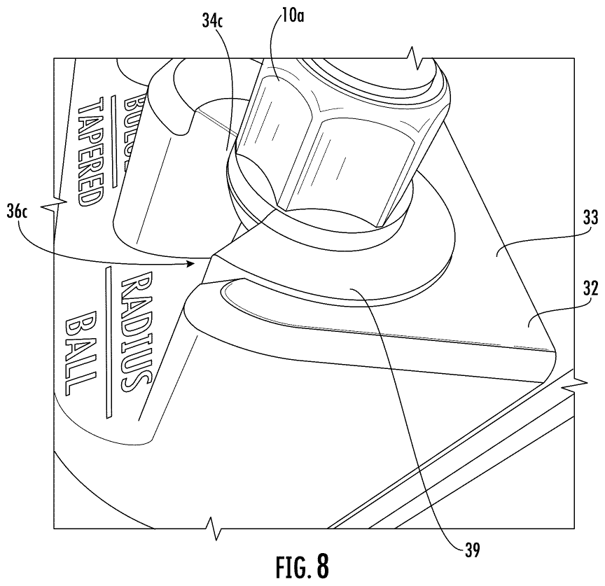

With reference to FIGS. 8 through 10, each position in the gauge 20 has a top opening 26 and a seat 27 that is dimensioned for a specific wheel lug or bolt. The seat 27 is configured to complement the geometric configuration associated with the interior portion of the typically exposed lug fitting for a removal tool. FIG. 8 illustrated the case where a wheel bolt is being verified. In this case, an aperture 28 beneath the seat 27 is dimensions for a specific shaft size associated with the exposed portion of the bolt. The correct thread pattern may be determined by using the female threaded apertures 30-2 and 30-3 in the thread verifier 30. In this configuration, it is also possible to verify a proper length for the shaft by sizing the aperture 28 accordingly.

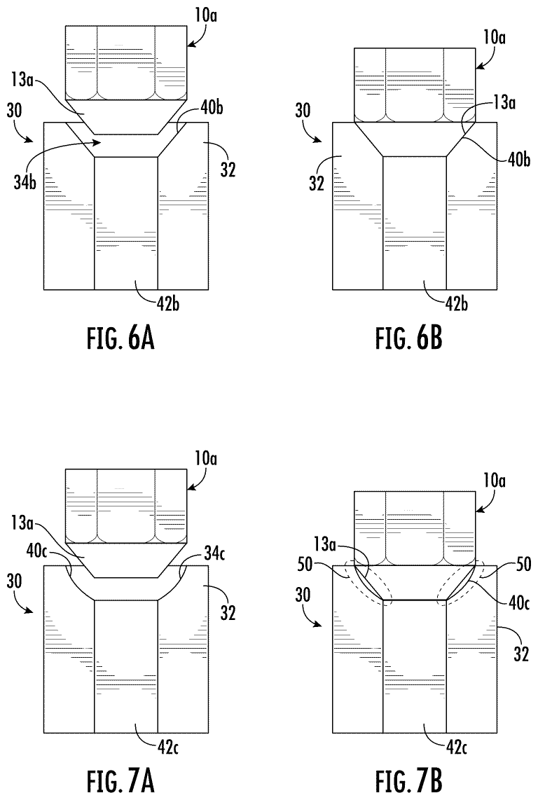

Having described the general structure of the gauge 30 according to an embodiment of the disclosure, use thereof will be described with reference to FIGS. 6A-10B. Turning first to FIGS. 6A-8, a user may determine the configuration of their lug nut/bolt aligning the lug nut/bolt seat contacting surface 13a-13g with one of the gauge slots 34a-34c (see FIGS. 6A, 7A, 9A and 10A) and then inserting the seat contacting surface 13a-13g into the seat portion 40a-40c as far as it will go (see FIGS. 6A, 7A, 9A and 10A). The user then checks through the open area 36a-36c to see if the forward face 13a-13g properly seats in the seat portion 40a-40c. In the example shown in FIG. 6B, the tapered face 13a of the tapered lug nut 10a seats properly in seat portion 40b of gauge slot 34b, however, when positioned in the seat portion 40c of gauge slot 34c, as shown in FIG. 7B, the forward face 13a does not completely seat and gaps 50 exist between the forward face 13a and the seat portion 40c. It is noted with reference to FIG. 8 that with a gauge only viewed from the top, for example, a gauge without an open front area, the tapered lug nut 10a may appear to properly fit in the radius seat portion 40c because the radius is larger than the maximum diameter of the taper. However, with the gauge 30 of the present disclosure, the front open area 36a-36c allows the user to quickly see that the lug nut 10a has a tapered configuration, not a radius or ball configuration. With the example shown in FIGS. 9B and 10B, the ball lug bolt 13g seats completely within the radius seat portion 40c of gauge slot 34c, but does not fit entirely within or seat properly in the tapered seat portion 40b of gauge slot 34b. The same result would happen if a tapered or balled seat contacting surface is positioned in the flat seat portion 40a of gauge slot 34a. Once the proper lug nut/bolt configuration is identified, the user can then confidently shop for a replacement part having the same configuration.

Referring to FIG. 11, the gauge 20 may be included in a larger gauge assembly 60. The gauge assembly 60 includes a support board 62 onto which the gauge 30 is attached, for example, via the mounting holes 46. Additionally, a sizing gauge 64 is also secured to the board 62. The sizing gauge 64 includes a plurality of threaded studs 66a-66h having varying diameters, and/or thread pitches and a plurality of threaded bores 68a-68b having different diameters and/or thread pitches. A user can utilize the threaded studs 66a-66h to determine the proper thread sizing of their lug nut or utilize the threaded bores 68a-68b to determine the proper thread sizing of their lug bolts.

What is claimed is:

1. A gauge for identifying a seat contacting surface configuration of a wheel fastener, the gauge comprising:
a body defining an upper surface and a front face with at least one gauge slot defined in the body; each gauge slot extending from the top surface and having a circumferential wall extending about a portion thereof with an open area defined in the circumferential wall along the front face and opening into at least a portion of the gauge slot;
the gauge slot including at least a seat portion adjacent the upper surface and defining a seat corresponding with a given seat contacting surface configuration of a wheel fastener.

2. The gauge according to claim 1 wherein the body defines at least two gauge slots and the seat portion of each of the gauge slots defines a seat corresponding with a different one of the given seat contacting surface configurations of a wheel fastener.

3. The gauge according to claim 2 wherein the given seat contacting surface configurations are selected from a group including a flat configuration, a tapered configuration and a radius configuration.

4. The gauge according to claim 1 wherein the body defines at least three gauge slots and the seat portion of each of the gauge slots defines a seat corresponding with a different one of the given seat contacting surface configurations of a wheel fastener.

5. The gauge according to claim 4 wherein the given front end configurations are selected from a group including a flat configuration, a tapered configuration and a radius configuration.

6. The gauge according to claim 1 wherein the wheel fastener is a lug nut.

7. The gauge according to claim 1 wherein each gauge slot further includes a through bore extending from the respective seat portion.

8. The gauge according to claim 7 wherein the wheel fastener is a lug nut or a lug bolt.

9. A gauge assembly comprising:
a support board;
a gauge according to claim 1 secured to the support board; and
a sizing gauge including a plurality of threaded studs, the threaded studs having different diameters and/or thread pitches.

10. The gauge assembly according to claim 9 wherein the sizing gauge further includes a plurality of threaded bores, the threaded bores having different diameters and/or thread pitches.

11. A method of identifying a seat contacting surface configuration of a wheel fastener, the method comprising:
a. positioning a seat contacting surface of the wheel fastener in the seat portion of a first of the gauge slots of the gauge according to claim 2;
b. observing the wheel fastener seat contacting surface in the seat portion of the first of the gauge slots through the open area;
c. determining if the wheel fastener seat contacting surface properly seats in the seat portion of the first of the gauge slots; and
d. if the wheel fastener seat contacting surface does not properly seat in the seat portion of the first of the gauge slots, repeating steps a-c in another of the gauge slots.

12. A gauge for sizing a wheel fastener, the gauge comprising:
a body having a predetermined geometric configuration that includes a top surface, a front surface, a back surface, and at least one fastener gauge;
the top surface includes an aperture with a seat dimensioned to receive a fastener with a specific geometric configuration;
the front surface has an opening that exposes a fastener positioned in the seat;
whereby a properly sized fastener can be determined by visual inspection of the fastener within the gauge.

13. The fastener of claim 12, wherein an aperture beneath the seat is dimensioned to receive a shaft associated with a fastener and determine whether a shaft is of a proper size for a fastener application.
